(19) United States
(12) Patent Application Publication
(10) Pub. No.: US 2002/0063621 A1
(43) Pub. Date: May 30, 2002

(54) Method and apparatus for device communications

(75) Inventors: George Tseng, Los Angeles, CA (US); Eric Roth, Los Angeles, CA (US); David Roth, Los Angeles, CA (US)

Correspondence Address: NEXT PLANET, IN.C, 175 S. FAIR OAKS AVE., PASADENA, CA, 91105, US

(73) Assignee: Next Planet, Inc., Los Angeles, CA

(21) Appl. No.: 09/683,337

(22) Filed: Dec. 16, 2001

Related U.S. Application Data
(63) Continuation-in-part of application No. 09/653,481, filed on Sep. 1, 2000.

(51) Int. Cl. H04L 12/28

(52) U.S. Cl. 340/2.7; 370/431

(57) ABSTRACT

A method of determining a communications channel including detecting whether a host is in a system; if a host is detected, querying the host for a channel on which to communicate and switching a channel selection logic based on a result from the query; and if a host is not detected, determining a channel on which to communicate based on the number of devices on each channel.

### CROSS REFERENCE TO RELATED APPLICATIONS

The present application is a continuation-in-part of application Ser. No. 09/653,481, filed Sep. 1, 2000, entitled “Circular Connector System,” by inventors David Goetz and David Roth, currently pending (attorney docket number RP.P001). This application is incorporated herein by reference.

### BACKGROUND OF INVENTION

Electronic equipment is becoming ubiquitous in the modern household. A consumer may own one or more devices, such as set-top boxes, multimedia game players, stereos, computers, Internet appliances and other home entertainment devices. From time to time, a consumer will desire to add additional components to the system by purchasing an electronic device. However, current electronic equipment does not provide a convenient mechanism for interfacing additional devices or components. Current systems do not allow additional electronic devices or components to be added to an electronics device system to allow consumers to add additional electronic devices or components easily, without wasting space or requiring an additional wires or cables.

One possible solution that has been proposed is the creating of modular housings that are “stackable”, where each housing is identical in design and have matched “stacking surfaces.” However, devices may only be stacked with other devices from the same family (e.g., devices that have the same surfaces). In addition, this solution does not eliminate the need to interconnect the devices with cables after the devices have been stacked.

Thus, a system that addresses one or more of the above problems is desirable.

### BRIEF DESCRIPTION OF DRAWINGS

The system is illustrated by way of example and not limitation in the figures of the accompanying drawings in which like references indicate similar elements and in which:

FIG. 1 is a perspective view of a second modular electronics device being placed on top of a first modular electronics device.

FIG. 2 is a front view of the second modular electronics device after it has been placed on top of the first modular electronics device.

FIG. 3 is an isometric view of a plug connector in one embodiment of the present invention.

FIG. 4 is an isometric view of a receptacle connector in one embodiment of the present invention.

FIG. 5 is a block diagram of a generalized stacking architecture configured in accordance with one embodiment of the present invention supporting a set of channels.

FIG. 6 is a block diagram of a stacking device used in the generalized stacking architecture configured in accordance with one embodiment of the present invention for use on a particular channel.

FIG. 7 is a block diagram of a dynamically configurable stacking device used in the generalized stacking architecture configured in accordance with one embodiment of the present invention to be dynamically operable on any channel in the set of channels supported by the generalized stacking architecture.

FIG. 8 is a block diagram of an exemplary stacking architecture configured in accordance with one embodiment of the present invention illustrating the use of the type of stacking devices as described in FIG. 6 in the system.

FIG. 9 is a block diagram of a stacking architecture configured in accordance with one embodiment of the present invention supporting a set of channels using the Firewire protocol.

FIG. 10 is a block diagram of a Firewire stacking device used in the Firewire stacking architecture configured in accordance with one embodiment of the present invention for use on a particular channel.

FIG. 11 is a block diagram of a stacking architecture configured in accordance with one embodiment of the present invention supporting a set of channels using the Universal Serial Bus (USB) protocol.

FIG. 12 is a block diagram of a USB stacking device used in the USB stacking architecture configured in accordance with one embodiment of the present invention for use on a particular channel.

FIG. 13 is a block diagram of a stacking architecture configured in accordance with one embodiment of the present invention supporting a set of channels using multiple communication protocols.

FIG. 14 is a block diagram of a stacking device used in the multiple communication protocol5 stacking architecture configured in accordance with one embodiment of the present invention for use on one or more particular channels.

FIG. 15 is a block diagram of a dynamically configurable stacking device used in the multiple communication protocols stacking architecture configured in accordance with one embodiment of the present invention to be dynamically operable on one or more channels in the set of channels supported by the multiple communication protocols stacking architecture.

FIG. 16 is a flow diagram of the operation of the dynamically configurable stacking device in FIG. 7 in one embodiment of the present invention.

### DETAILED DESCRIPTION

The present invention discloses a device communications architecture. In the following description, numerous specific details are set forth in order to provide a thorough understanding of the present invention. However, it will be apparent to one skilled in the art that the present invention may be practiced without these specific details. In other instances, well-known circuits, structures, and the like are not described in detail so as not to obscure the present invention unnecessarily. Moreover, although the present invention is described with reference to a set top box, it will be appreciated that the invention has application to other systems where electronic devices must be mechanically and electrically coupled together. Accordingly, the specific reference to a modular set-top box in this Specification is not to be understood as a limitation in the application of the invention.

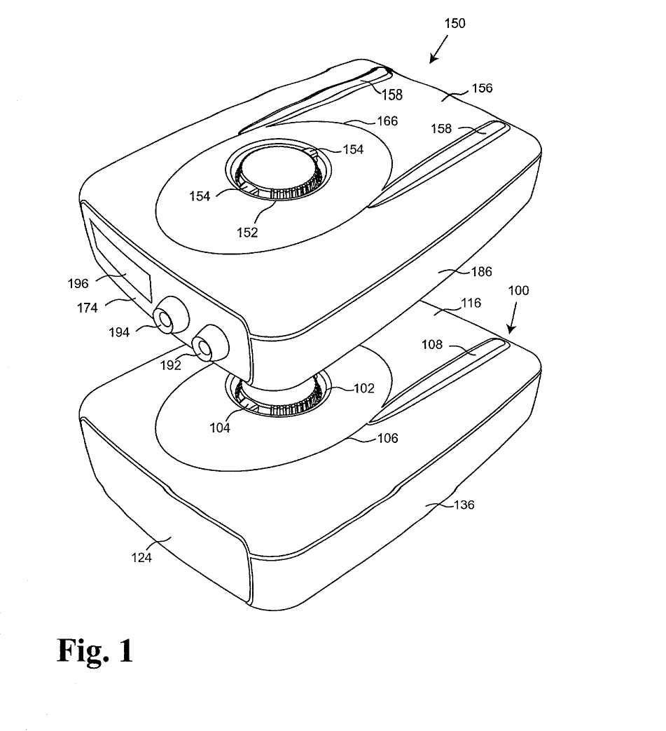

FIG. 1 is a perspective view of a second modular electronics device 150 in position to be stacked on top of a first modular electronics device 100. First modular electronics device 100 includes a top surface 116 and a bottom surface 136 configured in accordance with one embodiment of the present invention. First modular electronics device 100 also has a front surface 124 (e.g., a “front facia”) and a back surface (e.g., “rear facia”) (not shown).

Top surface 116 includes a top connector 102 and a set of protrusions. In one embodiment, top connector 102 is a connector as substantially disclosed in the patent application entitled “Circular Connector System,” as referenced herein. In another embodiment, top connector 102 may be any other connector that provides for electrical contact when an oppositely mated connector is placed on top of it. In addition, top connector 102 also provides mechanical interconnectivity between first modular electronics device 100 and a device that is stacked on it. Top connector 102 has a set of keying/alignment elements 104 to align top connector 102 and first modular electronics device 100 to the bottom connector on second modular electronic device 150 or another complementarily configured electronics device.

The set of protrusions on top surface 116 of first modular electronics device 100 includes an oval convex surface 106 and a set of rails 108. The set of protrusions are used to assist in the alignment of first modular electronics device 100 to another complementarily configured electronic devices. In other embodiments, instead of oval convex surface 106 or set of rails 108, first modular electronics device 100 may include other convex or concave surfaces. In yet another embodiment, the set of protrusions does not exist, and only set of keying/alignment elements 104 of top connector 102 is used for alignment.

Second modular electronics device 150 includes a top surface 156 and a bottom surface 186 configured in accordance with one embodiment of the present invention.

Second modular electronics device 150 also has a front surface 174 (e.g., a “front facia”) and a back surface (e.g., “rear facia”) (not shown). Front surface 174 includes a first control 192, a second control 194, and a display 196.

Top surface 156 of second modular electronics device 150 includes a top connector 152 and a set of protrusions. In one embodiment, top connector 152 is a connector as substantially disclosed in the Circular Connector System, above. In another embodiment, top connector 152 may be any other connector that provides for electrical contact when an oppositely mated connector is placed on top of it. In addition, top connector 152 also provides mechanical interconnectivity between second modular electronics device 150 and the device that is stacked on it. Top connector 152 has a set of keying/alignment elements 154 to align top connector 152 and second modular electronics device 150 to another complementarily configured electronics device.

The set of protrusions on top surface 156 of second modular electronics device 150 includes an oval convex surface 166 and a set of rails 158. The set of protrusions are used to assist in the alignment of second modular electronics device 150 to appropriately configured electronic devices. In other embodiments, instead of oval convex surface 166 or set of rails 158, second modular electronics device 150 may include other convex or concave surfaces. In yet another embodiment, the set of protrusions does not exist, and only set of keying/alignment elements 154 of top connector 152 is used for alignment.

The stacking is performed with second modular electronics device 150 being placed on top of first modular electronics device 100, with the bottom connector of second modular electronics device 150 being placed in contact with top connector 102 of first modular electronics device 100. Electrical and power connections are provided between the devices through the use of the connectors, without having to use external cables. In addition, the weight of second modular electronics device 150 and the interlocking mechanism of the connectors assist to keep the devices mechanically mated.

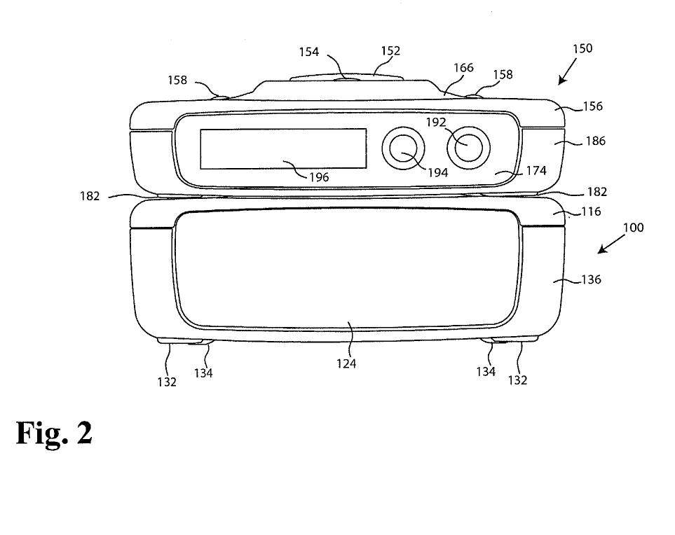

FIG. 2 is a front view of second modular electronics device 150 stacked on top of first modular electronics device 100. Second modular electronics device 150 includes a set of front feet 182 and a set of rear feet (not shown). The set of rear feet on bottom surface 186 is used to engage set of rails 108 such that the inside edge of each foot of the set of rear feet is touching the outside edge of each rail of the set of rails 108. First modular electronics device 100 also includes a set of front feet 132 and a set of rear feet 134. In one embodiment, the placement of set of front feet 132 and set of rear feet 134 on bottom surface 136 and bottom surface 186, respectively, are in substantially identical positions. In addition, oval concave surface 106 is engaged by a mated concave surface on bottom surface 186 (not shown).

In one embodiment, first modular electronics device 100 contains electronics to provide set top box functionality such as television tuning, digital audio encoding/decoding, digital video encoding/decoding, and data storage. First modular electronics device 100 may be coupled to a computer system or a television display (a “host”). In other embodiments, first modular electronics device 100 may be used to house other electronic components including, but not limited to, hard disk drives, printed circuit boards (PCB), and other devices. Second modular electronics device 150 contains electronics that adds features to first modular electronics device 100 and a connected host. For example, second modular electronics device 150 contains a mass media storage device such as a hard drive, which adds capacity to the system.

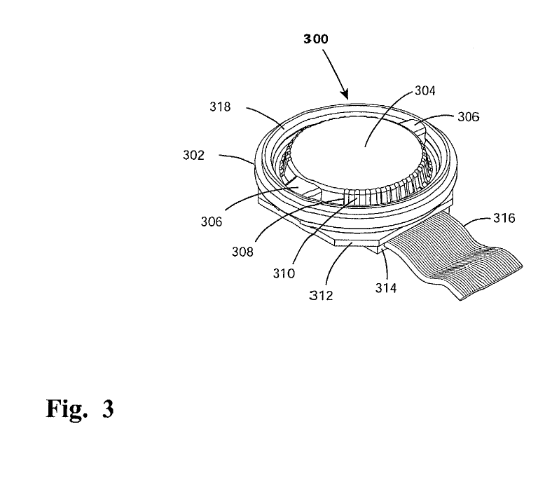

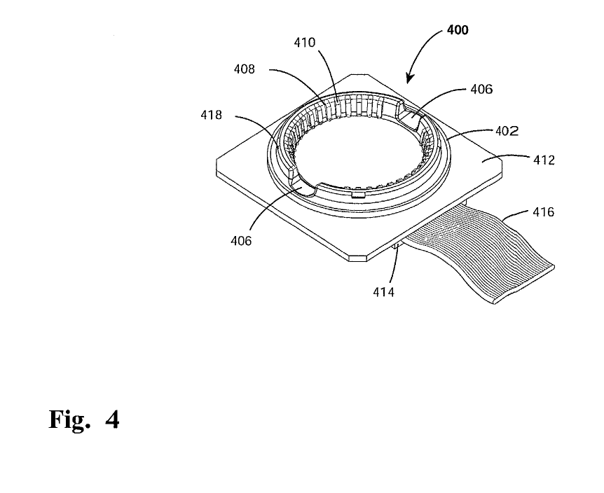

FIG. 3 is an isometric view of a plug connector 300 configured in accordance with one embodiment of the present invention, including a circular housing 302 configured to mate with a receptacle connector 400 as shown in FIG. 4. Housing 302 contains an integrated keying/alignment element 306 and a set of openings 308 displaced around a center portion 304. A set of contacts 310 is accessible through set of openings 308. In another embodiment, set of contacts 310 includes additional contacts accessible through a second set of openings displaced on an outer perimeter 318. In yet another embodiment, set of openings 308, instead of being displaced around center portion 304, is only displaced around outer perimeter 318.

As shown in FIG. 3, a ribbon cable 316 is connected to plug 314 to access a set of traces (not shown) in circuit board 312. Plug 314 is attached to a set of pins (not shown) on circuit board 312. Through ribbon cable 316, plug connector 300 can connect to another circuit board or other components. In another embodiment, the set of traces in circuit board 312 may be accessed through a set of contact surfaces on top of circuit board 312.

Housing 302 may be made of any single type of or composite material such that the material surrounding set of openings 308 is not conductive to electricity. In one embodiment, housing 302 is made of a plastic material, such as Acrylonitrile-Butadiene-Styrene (ABS). In another embodiment, housing 302 may be made out of a clear plastic material. In yet another embodiment, housing 302 may be made out of a combination of plastic and metal materials, where portions of housing 302 may use metal to allow housing 302 to act as a conductor (e.g., for signal or for grounding), or as shielding. Again, the material used surrounding set of openings 308 is preferably not electrically conductive. In contrast, set of contacts 310 may be constructed using any conductive material. In one embodiment, set of contacts 310 may be constructed using gold. In another embodiment, set of contacts 310 may be constructed using copper. The choice of materials for housing 302, and set of contacts 310 is dependent on the application for the connector system.

FIG. 4 is an isometric view of receptacle connector 400. Receptacle connector 400 includes a circular housing 402 that has a keying/alignment element 406 and a set of openings 408. A set of contacts 410 protrudes from set of openings 408. In another embodiment, set of openings 408 may include a set of openings located on an outer perimeter 418. In this embodiment, set of contacts 410 includes a set of contacts that are accessible through the set of openings on outer perimeter 418. In yet another embodiment, set of openings 408 are located on outer perimeter 418. Set of contacts 410 is mounted to a circuit board 412 through a set of circuit board contacts 408 on circuit board 412 (not shown). Circuit board 412 is connected to a plug 414 that is on a ribbon cable 416. The above description of the materials used in the construction of plug connector 300 applies equally to receptacle connector 400.

The choices of which type of connectors (e.g., plug connector 300 and receptacle connector 400), as top connectors and bottom connectors in the modular electronic devices described herein are flexible and implementation specific. In one embodiment, top connector 102 of first modular electronics device 100 and top connector 152 of second modular electronics device 150 are of the plug connector type as described for plug connector 300. In addition, the bottom connector of first modular electronics device 100 and the bottom connector of second modular electronics device 150 are of the receptacle connector type as described for receptacle connector 400. In another embodiment, the top connectors are of the receptacle connector type as described for receptacle connector 400 and bottom connectors are of the plug connector type as described for plug connector 300. In other embodiments, other types of plugs and connectors that conform to the keying and spacing requirements between devices may be used.

The connectors may be attached to the surfaces of the electronic devices by a variety of means. In one embodiment, the connectors are fastened to the surfaces by a set of screw type fasteners. In another embodiment, the connectors are sonically welded to the surfaces. In yet another embodiment, the connectors are trapped against the surfaces from the interior of the device such that the connectors are not able to move. In this embodiment, openings of sufficient size for the body of the connectors, but not the base of the connectors, to fit through are located in the surfaces of the device. One or more components inside the devices exert mechanical force against the connectors to keep the bases pressed against the opening. This keeps the connectors from moving both in the perpendicular or parallel axis to the surface on which they are located.

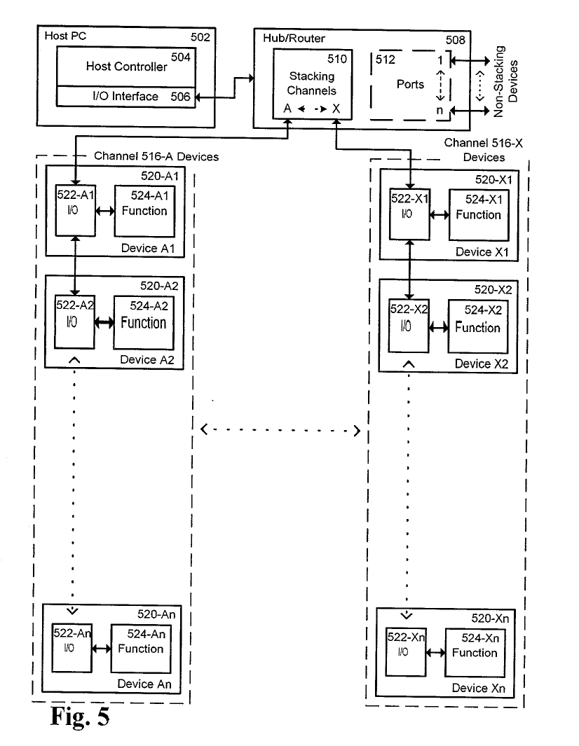

FIG. 5 is a block diagram of a stacking architecture configured in accordance with one embodiment of the present invention containing a host PC 502, a Hub/Router 508, and a group of devices organized into a series of channels 516-A to 516-X.

Host PC 502 contains a host controller 504 and an input/output (I/O) interface 506. In one embodiment, host PC 502 is a general purpose personal computer (PC) or workstation produced by such companies as IBM, Dell Computer Corporation, Compaq Computer Corporation, or Apple Computers, typically including a central processing unit (CPU), a mass storage device such as hard disk drives or compact disk read-only-memory (CD-ROM) drives, memory, a keyboard, a mouse, etc. Host controller 504 is a circuit that provides host PC 502 the ability to use one or more peripheral devices. In one embodiment, host controller 504 is a universal serial bus (USB) host controller as defined by the USB standard, version 2.0, available on the Internet from the USB lmplementer“s Forum at http://www.usb.org. I/O interface 506 is a circuit for implementing the physical input/output interface to communicate with one or more peripheral devices. In one embodiment, I/O interface 506 is the USB I/O interface as defined in the USB v2.0 specification. In another embodiment, I/O interface 506 is the interface described by the Institute of Electronics and Electrical Engineers (IEEE) 1394-1995a standard, also known as “Firewire” or “i.LINK,” the former is a trademark of Apple Computer, Inc. and the latter is a trademark of Sony Corporation. In this document, references to the IEEE 1394-1995a standard will use “Firewire,” but the above three terms will be used interchangeably herein. In yet another embodiment, a network protocol such as IEEE-802.3 Ethernet or IEEE-802.11 Wireless Ethernet may be used. In still yet another embodiment, a mixed multiple channel architecture of USB, FireWire, Ethernet and/or other communication protocols may be used.

Typically, most computers come with a limited number of interfaces (e.g. one or two USB ports and/or one or two Firewire ports). Hub/Router 508 is an electronic device that provides interconnectivity between a host and a group of other devices using a compatible communications protocol. Specifically, Hub/Router 508 provides host PC 502 additional ports and thus the ability (i.e., ports) to communicate with as many devices as is supported by Hub/Router 508. Host PC 502 is connected to Hub/Router 508 through I/O interface 506. Hub/Router 508 contains a set of stacking channels 510, channels A to X, and, optionally, a set of non-stacking ports 512. Set of non-stacking ports 512 are used to communicate with a set of non-stacking devices (not shown). Non-stacking ports 512 are optional and allow Hub/Router 508 to communicate with devices that do not have the proper electronics or physical interfaces for stacking.

In one embodiment of the present invention, a variety of devices are connected to Hub/Router 508 through set of stacking channels 510. Each channel is able to support a set number of devices, which is multiplied by the number of channels supported by Hub/Router 508 to determine the total number of supportable devices. For example, a group of channel A devices 516-A is shown in FIG. 5, containing a set of devices 520-A1 to 520-An.

All devices contain an I/O module and a function module. The I/O module of each device, in one embodiment, implements the same I/O protocol as Hub/Router 508 and I/O interface 506 of host PC 502. Moreover, in one embodiment, the I/O module of each device also includes hub/bridge functionality, such that each device can provide upstream and downstream capabilities. Each device provides a function that can be accessed by host PC 502 through the I/O module. For example, device 520-A1 may include a function 524-A1 such as a mass storage device (e.g. as a hard drive). Function 524-A1 may also be CD-ROM drive or another type of computer peripheral device such as a television (TV) tuner, a Motion Picture Experts Group (MPEG) Layer3 (MP3) audio encryption capable player, or a digital camera. Function 524-A1 may also be a multi-function unit, combining one or more features that may be added to host PC 502.

Up to any number of channels may be supported by Hub/Router 508. In FIG. 5, there is X-number of channels in set of stacking channels 510, each capable of supporting n-number of stacking devices. The number of channels and the corresponding number of devices per channel may be limited by the implementation specific protocol choices for the system. For example, if the protocol is based on the Firewire standard, up to 1,023 channels may be supported, with each channel supporting up to 63 devices. In addition, depending on the specific embodiment and the protocols used, the number of channels dedicated to the non-stacking devices connected to set of non-stacking ports 512 may decrease the number of devices/channels that may be used in set of stacking channels 510 to support stacking devices. Hub/Router 508 may be implemented using the same architecture as the devices it supports, as described below.

It is to be noted that the architecture shown in FIG. 5 does not necessarily illustrate the physical configuration of the devices and how they interconnect. Thus, the architecture described and shown in FIG. 5 may be implemented in many physical embodiments. For example, the architecture described above may be used for devices that are not stacked vertically, as described above in FIG. 1 and FIG. 2. The architecture may also be used for devices that are interconnected horizontally using connectors that are on different sides of the devices. Moreover, the devices do not necessarily need to be interconnected using the Circular Connector System, but may be interconnected with other types of connectors and/or cables. In addition, the interconnections may also be made using wireless technologies, as described herein.

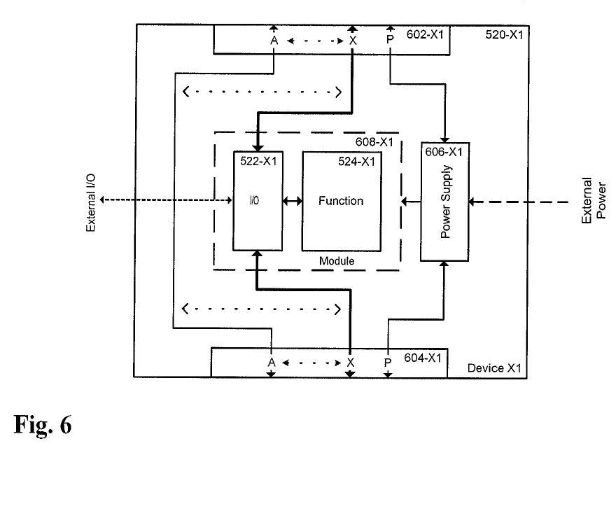

FIG. 6 is a block diagram of a device 520-X1 configured in accordance with one embodiment of the present invention for use in the stacking architecture as shown in FIG. 5. The description of device 520-X1 also applies generally to the other devices shown in FIG. 5, as further described herein. Moreover, FIG. 6 elaborates on the description of how a particular device is configured to be a device for a specific channel. Thus, while FIG. 5 is meant to show a generic architectural overview, FIG. 6 provides a generic device overview. Device 520-X1 contains a first stacking connector 602-X1 and a second stacking connector 604-X1, both of which are coupled to a power supply 606-X1. In addition, first stacking connector 602-X1 and second stacking connector 604-X1 are also coupled to a module 608-X1. Module 608-X1 contains an I/O unit 522-X1 and a functional unit 524-X1. In one embodiment, a device is “assigned” a particular channel by the fact that the I/O unit of that device is physically connected to a particular set of pins on the stacking connectors for a particular channel. For example, referring to FIG. 6, device 520-X1 is a channel X device as I/O 522-X1 is connected to the contacts assigned to channel X for the system. In another example, where a device is assigned to channel A, the I/O unit for that device is coupled to the contacts used for channel A in first stacking connector 602-X1 and second stacking connector 604-X1. Device 520-X1 may also be accessed through an external I/O connection, as indicated by the dashed line. In this scenario, other devices of the same channel may be accessed by the external I/O connection.

In the embodiment shown in FIG. 6, power may be obtained by power supply 606-X1 through use of the contacts assigned to a power channel P on first stacking connector 602-X1 or second stacking connector 604-X1. Optionally, power supply 606-X1 may also utilize an external power source, as indicated by the dashed line in FIG. 6 to “External Power.” Power supply 606-X1 may be configured to receive some or all of its power from either of the two sources. And in yet another embodiment, power supply 606-X1 may supply power to other devices on the stack using the power channel P. In still yet another embodiment, power supply 606-X1 may be one of the devices in the stack that provides power for the whole stack. In particular implementations, it is beneficial to only need one device that is plugged into a power source. The other devices may then be powered off of this powered device. In the particular embodiment where device 520-X1 is supplying power to other devices, device 520-X1 may contain a power management system to control the provision of power to other devices. For example, device 520-X1 can determine the timing and amount of power that is provided to other devices. Moreover, the power supplied on the power channel may be in addition to and/or separate from the power provided by the I/O protocol(s) used in the system. For example, the USB I/O protocol has provisions for a 5-volt (V), 500-milliamp (ma) power source that may be used by each device. The power channel for the system may include additional power channels to support USB power channels. Thus, a system may include one or more channels and/or sub-channels for power. Further, depending on the particular requirements of the system, the power supply contained in each device may only need to contain circuitry needed to interface with an external power supply module that supply any necessary primary alternating current (AC)/direct current (DC) down/up conversion and/or filtering features.

Using the architecture as described herein, a system of stacked devices is created by simply physically putting one stacking device on top of another, and pressing down on the top device such that the bottom connector of the top device is in contact with the top connector of the bottom device. As seen in FIG. 2, second modular electronics device 150 is stacked on top of first modular electronics device 100, with the bottom connector of second modular electronics device 150 being stacked on top connector 102 of first modular electronics device 100. In one embodiment, first modular electronics device 100 is connected to the host computer, and second modular electronics device 150 communicates with the host computer through its connection with first modular electronics device 100.

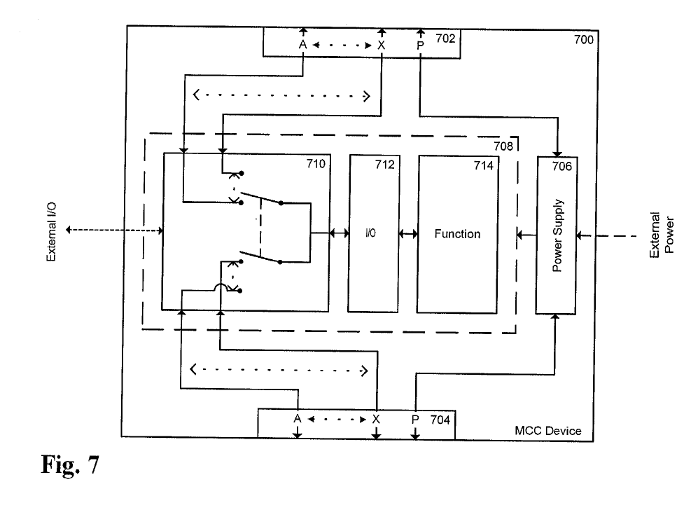

FIG. 7 is a block diagram of a multi-channel capable (MCC) device 700 configured in accordance with one embodiment of the present invention. MCC device 700 includes a first stacking connector 702 and a second stacking connector 704, both of which are coupled to a power supply 706. As described above, each stacking connector contains a set of contacts for a variety of purposes, such as providing power and data connectivity between each device. Specifically, first stacking connector 702 and second stacking connector 704 contain a set of contacts for each channel, channel A to channel X, and also a set of contacts for power. MCC device 700 also contains a module 708, which includes a channel selection logic 710, an I/O unit 712 and a functional unit 714.

MCC device 700 is capable of selecting a particular channel on which it will communicate. MCC device 700 does this through the use of channel selection logic 710. In one embodiment, channel selection logic 710 is only used for selecting one channel out of a set of channels. In another embodiment, channel selection logic 710 may be used to select more than one channel in a set of channels. Thus, MCC device 700 does not have to be pre-configured or hardwired for operation on a particular channel but may be adapted dynamically to operate on any channel in the system. In one embodiment, the channel selection process is performed by determining the number of devices that are already communicating on a particular channel, the type of devices communicating on a particular channel, or the random selection of a particular channel. Once a particular channel has been selected, channel selection logic 710 couples the selected channel to I/O unit 712, which handles communication for function 714. The channels that are not selected are passed through channel selection logic 710.

MCC device 700 may also interact with another device in the system, including a host in the system, to select a particular channel. In one embodiment, MCC device 700 will automatically choose a default channel on which to communicate. For example, MCC device 700 may first configure itself as a channel A device, where channel selection logic 710 couples the contacts for channel A to I/O unit 712. Then, after MCC device 700 communicates with another device in the system, such as a host or another device, MMC device 700 will change channel selection logic 710 to couple I/O unit 712 to another channel if requested by the host or another device. If no channel change is requested or if the request is denied, channel selection logic 710 will remain coupled to channel A. Thus, MMC device 700 may choose a particular channel by itself or interact with other devices in the system to choose a particular channel.

Power supply 706 is similar to power supply 606-X1 and can selectively receive power from the power channel P or the External Power. Power supply 706 supplies power to MCC device 700, including module unit 708, and may also selectively supply power to other devices in the system. In addition, in a configuration where there are multiple power channels, channel selection logic 710 may be used to select among one or more power channels in addition to data channels. For example, channel selection logic 710 may be used to select one or more of the power channels available in the system through first stacking connector 702 or second stacking connector 704 (not shown). Channel selection logic 710 may also choose the source of power going into power supply 706 from such sources as the external power as represented in the dashed line in FIG. 7.

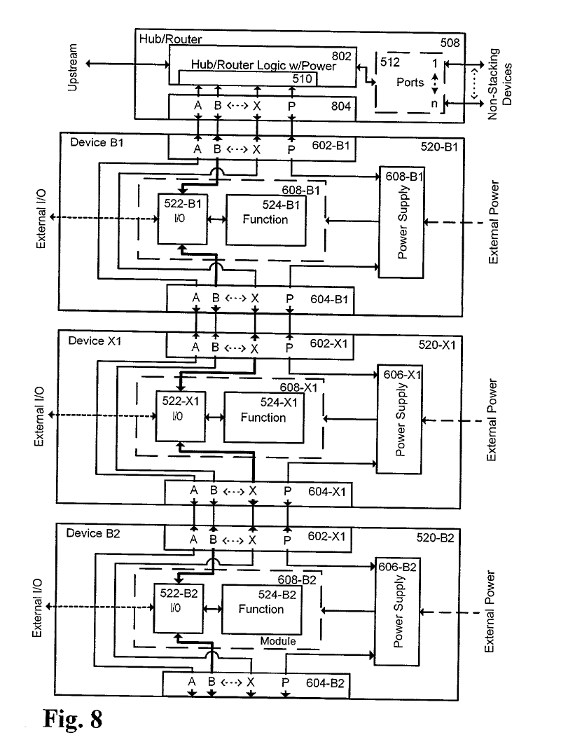

FIG. 8 is a block diagram illustrating one exemplary configuration of a stacking system configured in accordance with one embodiment of the present invention illustrating how stacking devices of the type described in FIG. 6 may be integrated into the stacking architecture of the type described in FIG. 5. In this exemplary configuration, a device 520-B1, a device 520-X1, and a device 520-B2 are stacked on top of Hub/Router 508 using the stacking connector system. Hub/Router logic unit 802 includes a stacking connector 804 coupled to Hub/Router logic unit 802 that provides a series of channels A-X, and a power channel P. Hub/Router 508 includes a Hub/Router logic unit 802, which is capable of supplying data in channels A-X and power through the power channel P to the stack using stacking connector 804.

Device 520-B1 is coupled to stacking connector 804 of Hub/Router 508 through a first stacking connector 602-B1. Compatible to stacking connector 804 of Hub/Router 508, first stacking connector 602-B1 includes a set of contacts for channels A-X, as well as a set of contact for power channel P. Device 520-B1 also includes a second stacking connector 604-B1, which includes the same contacts as first stacking connector 602-B1. In another embodiment, the stacking connectors may have contacts for different channels such that the channel supported by the first stacking connector are not identical to the channels supported by the second stacking connector. This allows a device to support two separate sets of devices, where each set of devices is connected to a different connector. In that case, the two sets of devices do not need to use the same channels and device 520-B1 may also be used as a switching or translating device.

Device 520-B1 is configured as a channel B device, as seen in FIG. 8, through the connection of the contacts for channel B in first stacking connector 602-B1 and second stacking connector 604-B1 to I/O unit 522-B1. In another embodiment, device 520-B1 may include channel selection logic similar to MCC device 700 to allow device 520-B1 to function on any channel. In this embodiment, all contacts would be coupled directly to the channel selection logic, and the connections that are not used are passed through.

Device 520-B1 also includes a function 524-B1, which provides one or more desired functions to the system. I/O unit 522-B1 and function 524-B1 are logically grouped in a module 608-B1. Device 520-B1 also contains a power supply 606-B1 that may be used to power device 520-B1, including module 608-B1. Power supply 606-B1 may operate off of the power received from Hub/Router 508 through the power channel P, through an external power source connected to 526-B1, from another device in the system (e.g. device 520-X1, or device 520-B2) through power channel P or from a configuration thereof. It would be desirable in some situations for power supply 606-B1 to operate off of the power supplied on power channel P, thus eliminating any need for additional wires for power modules to be connected to the system.

As illustrated in FIG. 8, devices from multiple channels may be coupled to each other through the use of one of several embodiments. Specifically, as illustrated in FIG. 8, one channel X device and two channel B devices are coupled to Hub/Router 508. The I/O unit of each device in the system is coupled only to the channel for which it has been configured. Other unused channels are passed through the device. For example, in device 520-X1, I/O unit 522-X1 is coupled to the contacts for channel X. The signal lines for the other channels are passed through from first stacking connector 602-X1 directly to second stacking connector 604-X1. In another embodiment, instead of a direct pass through for the signal lines of the unused channels, device 520-X1 may monitor the access and use of the other channels on which it is not configured: (1) to provide repeater/signal strengthening functionality, or (2) if the device is capable, to dynamically switch to another channel. In addition, for devices where power is not required, the power channel may be passed through the device.

For example, one of the stacking devices may be a docking station for a removable device such as a portable MP3 player. In this example, when the portable MP3 player is placed into the dock, the power supply circuitry (or the data circuitry of the portable MP3 player if the data circuitry integrates power supply circuitry) of the portable MP3 player is coupled to the power channel, similar to how the I/O unit of each device is coupled to the data channel. When the portable MP3 player is removed from the dock, the connectors for the power channels from the connectors on the device are coupled directly to each other; similar to the situation, where the data channels that are not for the device are passed through the device. In one configuration, switches and/or multiplexers may be used to accomplish this task.

Appropriate circuitry may also be placed into the system to ensure that no power loss occurs to the devices that are downstream from the dock. The discussion above also applies to a module being dynamically inserted a module into one of the channels, such as where the portable MP3 player is inserted into the dock. In that scenario, a connection is made between: (1) the contacts on the connectors for the channel to which the portable MP3 player is connected, and (2) the I/O unit of the MP3 player. In this embodiment, data flow might be disrupted for downstream devices as the data circuit of the MP3 player is coupled to the channel. In another embodiment, an additional I/O unit or circuitry that simulates an I/O unit may be used in the dock such that the dock is always in the channel even when a portable device such as the portable MP3 player is removed. When the MP3 player is inserted into the dock, the I/O unit of the MP3 player is then coupled to the I/O unit in the dock. In this document, a “downstream” device is defined to be a device that is farther away from the Hub/Router in the system in terms of connection than another referenced device, while an “upstream” device is a device that is closer in terms of connection than another referenced device. For example, referring to FIG. 5, comparing device 520-A1 and device 520-A2 as they are coupled to Hub/Router 508, device 520-A1 is upstream from 520-A2 and downstream from Hub/Router 508, while device 520-A2 is downstream from both 520-A1 and Hub/Router 508. In FIG. 8, device 520-B1 is downstream from hub/router 508 and upstream from device 520-B2, while device 520-B2 is downstream from device 520-B1. Device 520-X1 is downstream from hub/router 508, and on the same tier as device 502-B1.

As noted herein, devices may communicate with each other through connector systems other than the Circular Connector System. This includes not only physical connection technology, but also network connectivity solutions. For example, the second stacking connector 604-B2 of device 520-B2 may be connected to a network transceiver using such technologies as the IEEE-802.3 Ethernet standard. The transceiver is then connected to a network. A remote device may then be in communications with device 520-B2 through the network using another transceiver. Additional devices may then be connected to this remote device using the stacking architecture, which then increases the number of devices in the system. In this way, multiple stacks of products may be configured to be in communication. In addition, the connectivity between stacks may also be achieved using wireless connection technology. For example, the second stacking connector 604-B2 of device S20-B2 may be connected to a wireless transceiver using such technologies as the Bluetooth standard, or the IEEE 802.11 wireless Ethernet standard.

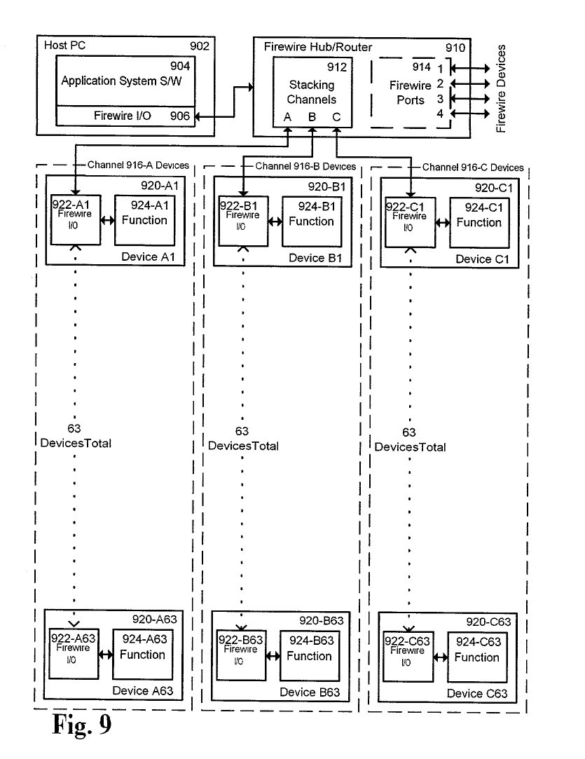

FIG. 9 is an architectural overview of a stacking system configured to use Firewire in one embodiment of the present invention, containing a host PC 902, a Firewire Hub/Router 910 supporting a set of stacking channels 912 including a channel A, a channel B, and a channel C to which a set of channel A devices 916-A, a set of channel B devices 916-B, and a set of channel C devices 916-C are coupled, respectively. In this particular embodiment, the I/O protocol implemented is the Firewire standard. This particular standard supports up to 1,023 channels with up to 63 devices per channel. For purposes of explanation, the exemplary embodiment in FIG. 9 includes only three channels with an optional set of non-stacking Firewire ports 914 being used to connect to non-stacking devices.

Host PC 902 is similar to a host PC as described for host PC 502, and contains an application system software 904 for supporting a Firewire I/O unit 906, which is responsible for communicating with Firewire Hub/Router 910. As described for the devices in FIG. 5, each channel device in FIG. 9 contains a Firewire I/O and a function. In addition, Firewire Hub/Router 910 may be implemented using a channel device.

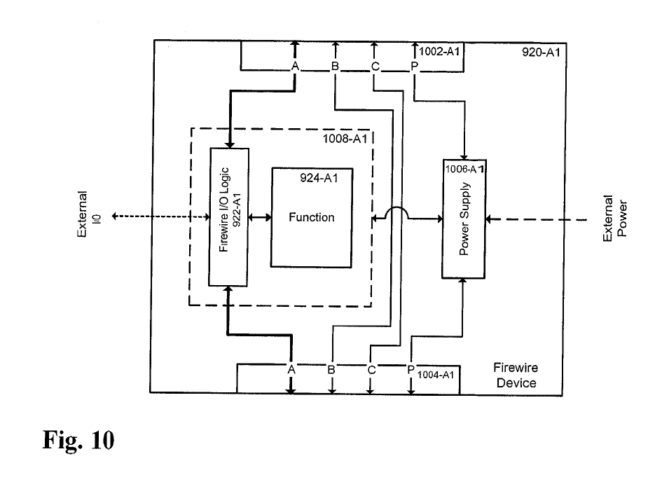

FIG. 10 is a block diagram of a Firewire device 920-A1 configured in accordance with one embodiment of the present invention based on the devices described in FIG. 6 . The description of Firewire device 920-A1 also applies generally to the other devices shown in FIG. 9, as further described herein. Moreover, FIG. 10 elaborates on the description of how a particular device is configured to be a device for a specific channel. Thus, while FIG. 9 is meant to show a generic architectural overview for Firewire, FIG. 10 is a generic device overview for a channel device based on Firewire. Firewire device 920-A1 contains a first stacking connector 1002-A1 and a second stacking connector 1004-A1, both of which are coupled to a power supply 1006-A1. In addition, first stacking connector 1002-A1 and second stacking connector 1004-A1 are also coupled to a module 1008-A1. Module 1008-A1 contains a Firewire I/O logic unit 922-A1 and a function unit 924-A1. In one embodiment, a device is assigned a particular channel by connecting the I/O unit of that device to a particular set of pins on the stacking connectors for a particular channel. For example, referring to FIG. 10, Firewire device 920-A1 is a channel A device as Firewire I/O logic unit 922-A1 is connected to the contacts assigned to channel A for the system. In another example, where a device is assigned to channel C, the I/O unit for that device is coupled to the contacts in first stacking connector 1002-A1 and second stacking connector 1004-A1 used for channel C.

Power supply 920-A1 provides the same functions as power supply 606-X1 and provides power to Firewire device 920-A1, including module 1008-A1. Power supply 920-A1 can selectively receive power from multiple sources such as from the power channel P or the External Power source, while also selectively supplying power to other devices in the system. In the embodiment shown in FIG. 10, power may be obtained by Firewire device 920-A1 through use of the contacts assigned to a power channel P on first stacking connector 1002-A1 or second stacking connector 1004-A1. Optionally, Firewire device 920-A1 may also utilize an external power source, as indicated by the dashed line. Moreover, the power supplied on the power channel may be in addition to and/or separate from the power provided by the I/O protocol(s) used in the system. For example, the Firewire I/O protocol has provisions for a 30-volt (V), 1.5-amp power source that may be used by each device.

As shown in FIG. 9, up to 63 Firewire devices may be interconnected per channel, and with 3 channels in the system as shown, a stack may be created to have up to 189 devices (3 channels×63 devices/channel=189 devices). In addition, in other physical embodiments, devices do not need to have the stacking connectors, but instead are physically interconnected through the use of cables connected to the Firewire I/O logic as shown by the dashed line labeled “External I/O.” These devices can be daisy chained using applicable cables with up to 16 devices as described in the Firewire standard. Each device“s FireWire I/O logic contains a repeater circuit that repeats all FireWire protocol commands not intended for the device itself back onto the daisy-chain cable medium.

Table 1 is an exemplary connector contact configuration for first stacking connector 1002-A1 and second stacking connector 1004-A1 of Firewire device 920-A1, where first stacking connector 1002-A1 is the bottom connector, and second stacking connector 1004-A1 is the top connector. In the embodiment where the connectors are circular, the sequence of the numbering of the contacts shown for the top and bottom connectors is done in a clockwise fashion. The numbering/labeling of the connectors is implementation specific.

TABLE 1
Exemplary Connector Contacts Configuration

| Top Contacts | Bottom Contacts | Functions | Category |
|---|---|---|---|
| 1 | 20 | VP (Power) | Channel A |
| 2 | 19 | VG (GND) | Channel A |
| 3 | 18 | TPB* | Channel A |
| 4 | 17 | TPB | Channel A |
| 5 | 16 | TPA* | Channel A |
| 6 | 15 | TPA | Channel A |
| 7 | 14 | VP (Power) | Channel B |
| 8 | 13 | VG (GND) | Channel B |
| 9 | 12 | TPB* | Channel B |
| 10 | 11 | TPB | Channel B |
| 11 | 10 | TPA* | Channel B |
| 12 | 9 | TPA | Channel B |
| 13 | 8 | VP (Power) | Channel C |
| 14 | 7 | VG (GND) | Channel C |
| 15 | 6 | TPB* | Channel C |
| 16 | 5 | TPB | Channel C |
| 17 | 4 | TPA* | Channel C |
| 18 | 3 | TPA | Channel C |
| 19 | 2 | Aux. Power (+) | Power Channel |
| 20 | 1 | Aux. Power (−) | Power Channel |

In FIG. 10 Firewire I/O logic unit 922-A1 is coupled to contacts 1-6 on second stacking connector 1004-A1 that is located on the top surface of the device (referred to as the top connector on the device), which are the contacts assigned to channel A for second stacking connector 1004-A1. In addition, Firewire I/O logic unit 922-A1 is coupled to contacts 15-20 on first stacking connector 1002-A1 that is located on the bottom surface of the device (referred to as the bottom connector on the device), which are also the contacts assigned to channel A for first stacking connector 1002-A1. Firewire I/O logic unit 922-A1 contains an upstream port for communicating with the channel, and one or more downstream ports for communicating with function units such as function 924-A1 and a downstream channel device such as Firewire device 920-A2. In one embodiment, contacts 1-6 are connected to one of the available downstream ports of hub 1122-A1, while the upstream port of hub 1122-A1 is connected to contacts 15-20. In other embodiments, where Firewire device 920-A1 contains multiple function units, the other function units may be connected to the other free downstream ports of Firewire I/O logic unit 922-A1. In general the number of function units that may be included in the device is based on the number of available downstream ports. Thus, either Firewire I/O logic unit 922-A1 is configured to have the requisite number of downstream ports—an n-port hub; or, in the alternative, one or more functions in the device cascaded off of the downstream ports of Firewire I/O logic unit 922-A1 may provide router functionality.

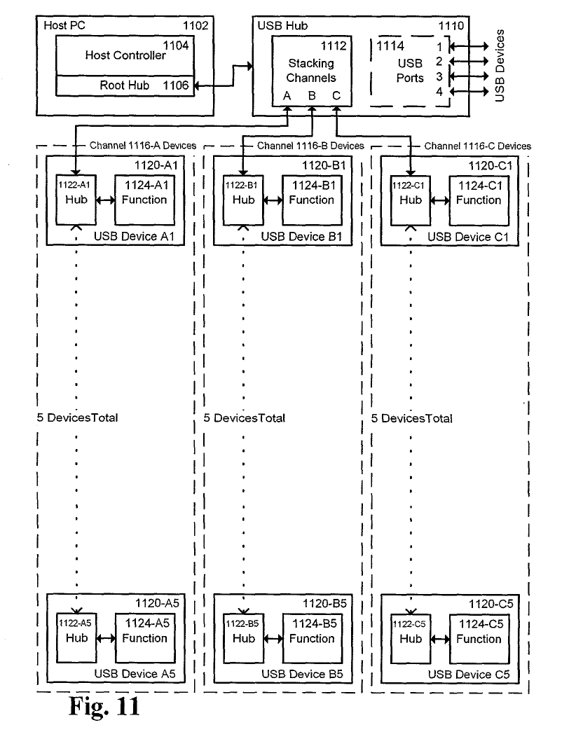

FIG. 11 is an architectural overview of a stacking system configured to use USB in one embodiment of the present invention, containing a host PC 1102, a USB Hub 1110, and a group of channel A devices 1116-A, a group of channel B devices 1116-B, and a group of channel C devices 1116-C. In this particular embodiment, the I/O protocol implemented is the USB standard. This particular standard supports up to 127 devices, with recommended limit of up to 7 layers of devices. For purposes of explanation, the exemplary embodiment in FIG. 11 only includes three channels, with 5 devices per channel. Also, for purposes of illustration, an optional set of non-stacking USB ports 1114 is used to connect to non-stacking USB devices.

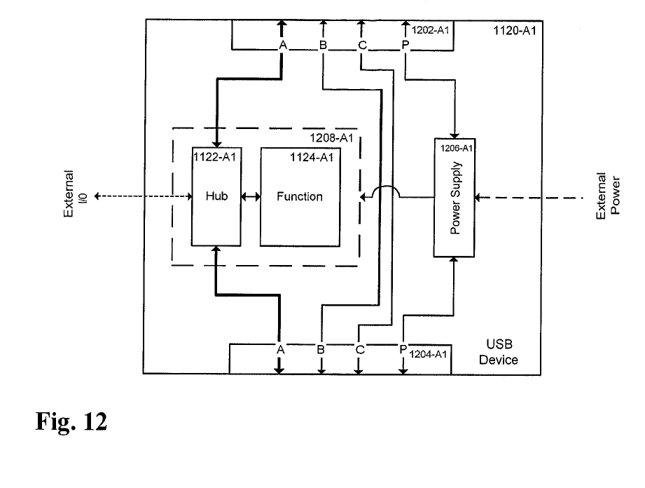

USB Hub 1110 includes a set of stacking channels 1112 having a channel A, a channel B, and a channel C to which a group of channel A devices 1116-A, a group of channel B devices 1116-B, and a group of channel C devices 1116-C are coupled, respectively. Host PC 1102 contains a host controller 1104 for supporting a root hub 1106, which is responsible for communicating with USB Hub 1110. FIG. 12 is a block diagram of a USB device 1120-A1 configured in accordance with one embodiment of the present invention based on the devices described in FIG. 6. The description of USE device 1120-A1 also applies generally to the other devices shown in FIG. 11, as further described herein. Moreover, FIG. 12 elaborates on the description of how a particular device is configured to be a device for a specific channel. Thus, while FIG. 11 is meant to show a generic architectural overview, FIG. 12 provides a generic device overview. USB device 1120-A1 contains a first stacking connector 1202-A1 and a second stacking connector 1204-A1, both of which are coupled to a power supply and control circuitry 1206-A1. In addition, first stacking connector 1202-A1 and second stacking connector 1204-A1 are also coupled to a module 1208-A1. Module 1208-A1 contains a Hub 1122-A1 and a function unit 1124-A1. In one embodiment, a device is assigned a particular channel by connecting the I/O unit of that device to a particular set of pins on the stacking connectors for a particular channel. For example, referring to FIG. 12, USB device 1120-A1 is a channel A device as Hub 1122-A1-A1 is connected to the contacts assigned to channel A for the system. In another example, where a device is assigned to channel C, the I/O unit for that device is coupled to the contacts in first stacking connector 1202-A1 and second stacking connector 1204-A1 used for channel C. USB device 1120-A1 may also be accessed through an external I/O connection, as indicated by the dashed line. In this scenario, other devices of the same channel may be accessed by the external I/O connection.

Power supply 1206-A1 provides the same functions as power supply 606-X1 and provides power to USB device 1120-A1, including USB module 1208-A1. Power supply 1206-A1 can selectively receive power from multiple sources such as from the power channel P or the External Power source, while also selectively supplying power to other devices in the system. In the embodiment shown in FIG. 12, power may be obtained by USB device 1120-A1 through use of the contacts assigned to a power channel P on first stacking connector 1202-A1 or second stacking connector 1204-A1. Optionally, USB device 1120-A1 may also utilize an external power source, as indicated by the dashed line. Moreover, the power supplied on the power channel may be in addition to and/or separate from the power provided by the I/O protocol(s) used in the system. For example, as mentioned above, the USB protocol has provisions for a 5V, 500 ma power source that may be used by each device.

As shown in FIG. 11, up to 5 USB stacking devices may be interconnected per channel, and with 3 channels in the system as shown, a stack may be created to have up to 15 devices (3 channels×5 devices/channel=15 devices). In addition, in other physical embodiments, devices do not need to have the stacking connectors, but instead are physically interconnected through the use of cables or other types of device interconnection systems.

Table 2 is an exemplary connector contact configuration for first stacking connector 1202-A1 and second stacking connector 1204-A1 of USB device 1120-A1, where first stacking connector 1202-A1 is the bottom connector, and second stacking connector 1204-A1 is the top connector. In the embodiment where the connectors are circular, the sequence of the numbering of the contacts for the top and bottom connectors is done in a clockwise fashion. The numbering/labeling of the connectors is implementation specific.

TABLE 2
Exemplary Connector Contact Configuration

| Top Contacts | Bottom Contacts | Function | Category |
|---|---|---|---|
| 1 | 14 | USB Data (+) | Channel A |
| 2 | 13 | USB Data (−) | Channel A |
| 3 | 12 | USB 5 V+ | Channel A |
| 4 | 11 | USB GND | Channel A |
| 5 | 10 | USB Data (+) | Channel B |
| 6 | 9 | USB Data (−) | Channel B |
| 7 | 8 | USB 5 V+ | Channel B |
| 8 | 7 | USB GND | Channel B |
| 9 | 6 | USB Data (+) | Channel C |
| 10 | 5 | USB Data (−) | Channel C |
| 11 | 4 | USB 5 V+ | Channel C |
| 12 | 3 | USB GND | Channel C |
| 13 | 2 | Aux. Power (+) | Power Channel P |
| 14 | 1 | Aux. Power (−) | Power Channel P |

In FIG. 12, hub 1122-A1 is coupled to contacts 1-4 on second stacking connector 1204-A1 that is located on the top surface of the device (referred to as the top connector on the device), which are the contacts assigned to channel A. In addition, hub 1122-A1 is coupled to contacts 11-14 on first stacking connector 1202-A1 that is located on the bottom surface of the device (referred to as the bottom connector on the device), which are also the contacts assigned to channel A. Hub 1122-A1 contains an upstream port for communicating with the channel, and a set of downstream ports for communicating with function units such as function 1124-A1 and a downstream channel device such as USB device 1120-A2. In one embodiment, contacts 1-4 are connected to one of the available downstream ports of hub 1122-A1, while the upstream port of hub 1122-A1 is connected to contacts 11-14. In other embodiments, where USB device 1120-A1 contains multiple function units, the other function units may be connected to the other free downstream ports of hub 1122-A1. In general, the number of function units that may be included in the device is based on the number of available downstream ports. Thus, either hub 1122-A1 is configured to have the requisite number of downstream portsan n-port hub; or, in the alternative, one or more functions in the device cascaded off of the downstream ports of hub 1122-A1 may provide hub functionality.

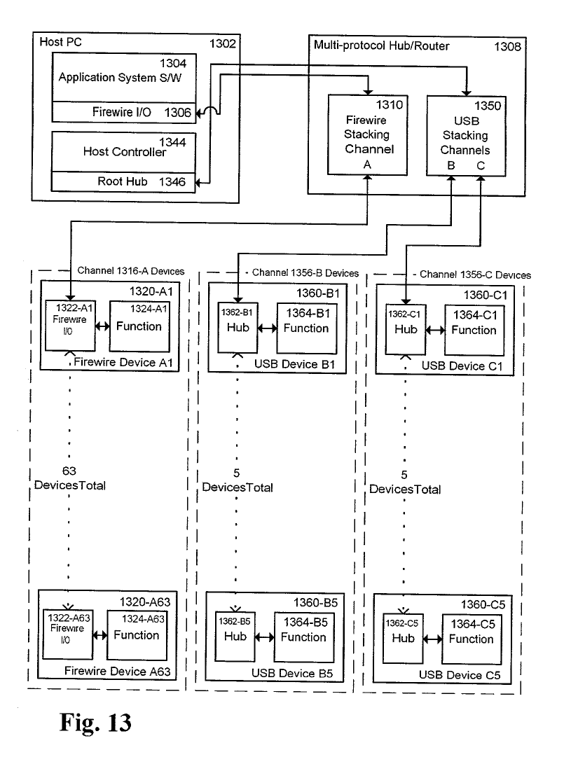

FIG. 13 is an architectural overview of a stacking architecture configured in accordance with one embodiment of the present invention to support multiple protocols, containing a host PC 1302, a multi-protocol hub/router 1308, and a set of channel A devices 1316-A, a set of channel B devices 1356-B, and a set of channel C devices 1356-C. In this particular embodiment, the supported I/O protocols are the Firewire and USB standards. For purposes of explanation, the exemplary embodiment in FIG. 13 only includes three channels: a Firewire channel supporting up to 63 devices, and two USB channels supporting up to 5 devices per channel.

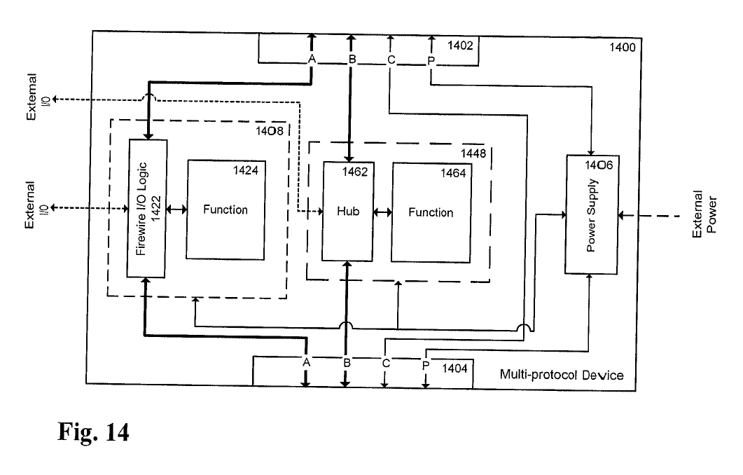

FIG. 14 is a block diagram of a multi-protocol capable (MPC) device 1400 configured in accordance with one embodiment of the present invention. MPC device 1400 includes a first stacking connector 1402 and a second stacking connector 1404, both of which are coupled to a power supply 1406. As described above, each stacking connector contains a set of contacts for a variety of purposes, such as providing power and data connectivity between each device. Specifically, first stacking connector 1402 and second stacking connector 1404 contain a set of contacts for each of three channels, channel A to channel C, and also a set of contacts for power. MPC device 1400 also contains a Firewire module 1408 that includes a Firewire I/O logic 1422 and a function unit 1424, and a USB module 1448 that includes a USB hub 1462, and a function 1464. In the embodiment shown in FIG. 14, USB hub 1462 is coupled to the contacts in the stacking connectors for channel B. Specifically, the upstream port of USB hub 1462 is coupled to the contacts of first stacking connector 1402, and a downstream port of USB hub 1462 is coupled to the contacts of second stacking connector 1404. Referring back to FIG. 13, channels B and C are used for USB traffic while channel A is used for Firewire traffic.

Power supply 1406 provides the same functions as power supply 606-X1 and provides power to MPC device 1400, including both Firewire module 1408 and USB module 1448. Power supply 1406 can selectively receive power from multiple sources such as from the power channel P or the External Power source, while also selectively supplying power to other devices in the system.

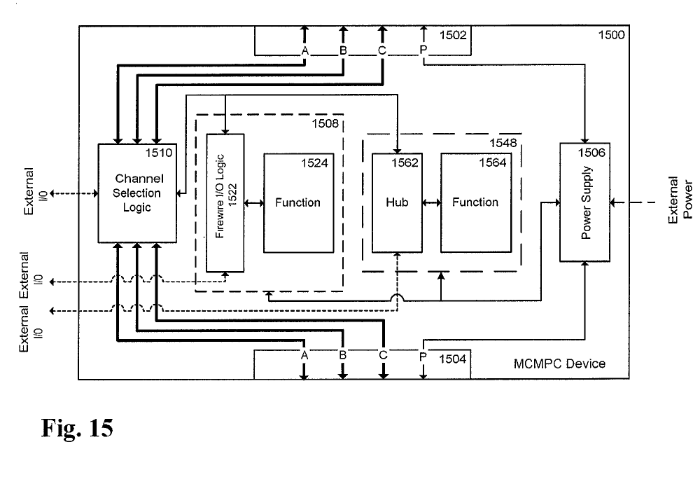

FIG. 15 is a block diagram of a multi-channel, multi-protocol capable (MCMPC) device 1500 configured in accordance with one embodiment of the present invention. MCMPC device 1500 includes a first stacking connector 1502 and a second stacking connector 1504, both of which are coupled to a power supply 1506 and a channel selection logic 1510. As described above, each stacking connector contains a set of contacts for a variety of purposes, such as providing power and data connectivity between each device. Specifically, first stacking connector 1502 and second stacking connector 1504 contain a set of contacts for each of three channels, channel A to channel C, and also a set of contacts for a power P. MCMPC device 1500 also contains a Firewire module 1508, which includes a Firewire I/O logic 1522 and a function 1524; and a USB module 1548, which includes a USB hub circuit 1562 and a function 1564. Channel selection logic 1510 is couple to Firewire module 1508 and USB module 1548 through Firewire I/O logic 1522 and USB hub circuit 1562, respectively.

MCMPC device 1500 is capable of connecting Firewire module 1508 and USB module 1548 to the particular channels on which they will communicate. MCMPC device 1500 does this through the use of channel selection logic 1510. In one embodiment, channel selection logic 1510 is used for channel selection for only one of the modules. For example, either Firewire module 1508 or USB module 1548 is hardwired to a particular channel and the non-hardwired module may be connected to any other channel. In another embodiment, channel selection logic 1510 may be used to perform channel selection for both modules. Thus, MCMPC device 1500 does not have to be pre-configured or hardwired for operation on one or more particular channels but can be adapted to choose any channels in the system dynamically. In one embodiment, the channel selection process is performed by determining the number of devices that are already communicating on a particular channel, the type of devices communicating on a particular channel, or the random selection of a particular channel. Once a particular channel has been selected for a particular I/O unit, channel selection logic 1510 couples the I/O unit to the selected channel. The channels that are not selected are passed through channel selection logic 1510.

MCMPC device 1500 may also be instructed by another device in the system, including a host in the system, to select a particular channel. In one embodiment, MCMPC device 1500 will automatically choose a default channel on which to communicate. For example, MCMPC device 1500 may first configure itself as a channel A device, where channel selection logic 1510 couples the contacts for channel A to Firewire I/O logic 1522. Then, after MCMPC device 1500 communicates with another device in the system, such as a host or another device, MCMPC device 1500 will change channel selection logic 1510 to couple Firewire I/O logic 1522 to another channel if requested by the host or another device. If no channel change is requested or if the request is denied, Firewire I/O logic 1522 will remain coupled to channel A. Thus, MCMPC device 1500 may choose a particular channel for each module by itself or receives a request to choose a particular channel for each module.

Power supply 1506 provides the same functions as power supply 706 and provides power to MCMPC device 1500, including both Firewire module 1508 and USB module 1548. Power supply 1506 can selectively receive power from multiple sources such as from the power channel P or the External Power source, while also selectively supplying power to other devices in the system. In addition, in a configuration where there are multiple power channels, channel selection logic 1510 may be used to select among one or more power channels in addition to data channels. For example, channel selection logic 1510 may be used to select one or more of the power channels available in the system through first stacking connector 1502 or second stacking connector 1504 (not shown). Channel selection logic 1510 may also choose the source of power going into power supply 1506 from such sources as the external power as represented in the dashed line in FIG. 15.

It is to be noted that devices configured in accordance with one or more of the embodiments described herein may be interconnected with each other as long as the contact configurations of the stacking connectors are compatible. As mentioned herein, the contact configurations of any two adjacent stacked devices do not have to be identical, as long as the contacts necessary for the channels that are to be coupled are in the right locations. For multi-channel devices, the contact configurations are dynamically configurable, which allows the multi-channel devices to be more readily adaptable to be used with any other device.

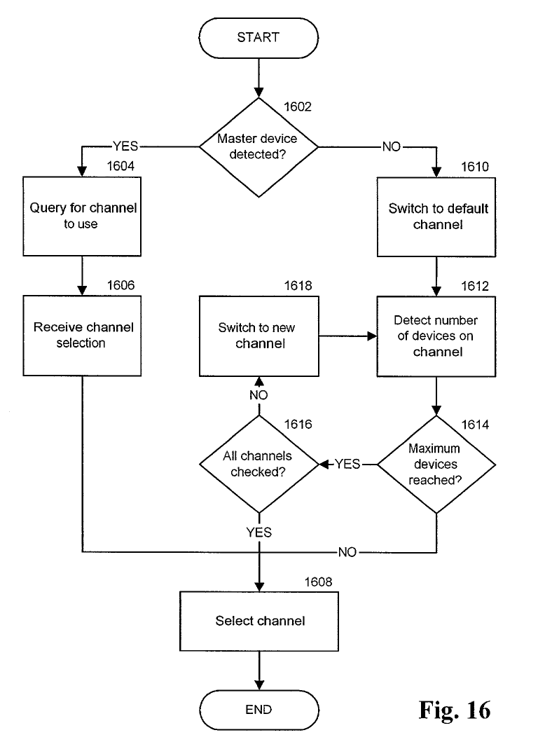

FIG. 16 is a flow diagram illustrating the operation of a multi-channel capable device. The flow diagram will be described using MCC device 700 as an exemplary device. Specifically, the flow diagram describes the channel selection process of the channel selection 710. However, it should be noted that the description would generally apply to all multi-channel capable devices. The process begins when MCC device 700 is placed in communication with one or more devices that are already connected to a host. In one embodiment, MCC device 700 is stacked on top of one of the devices, with first stacking connector 702 being coupled with the stacking connector of the bottom device.

In block 1602, once MCC device 700 is coupled to the system, channel selection logic 710 will determine if a master device exists in the system. In this description, a master device is any device that has control of assigning resources for devices such as communications channels, communication identities, data/time slots, or any other system resources. If a master device is detected, operation continues with block 1604. If a master device is not detected, operation continues with block 1610.

In block 1604, channel selection logic 710 will query the master device for a channel on which to communicate. During the query process, channel selection logic 710 may also transmit the capabilities of MCC device 700 to the master device. This allows the master device to update a table or database of information listing all the devices in the system and their capabilities. In addition, the information that is sent to the master device may also be used to determine the allocation of resources in the system by the master device. In one embodiment, the initialization communication will use a default channel designated to be the first channel on which all new devices initially communicates to set-up. In this embodiment, the default channel may also be used as a channel for normal communications, such that if all other channels are at a predetermined capacity and not able to accept other devices without potentially degrading performance, the default channel may be used as another channel. In another embodiment, a separate channel may exist and be used to communicate command and control data, separate from normal data communications. Once channel selection logic 710 has sent a channel request to the master device, operation continues with block 1606.

In block 1606, the master device sends a message to channel selection logic 710 with the channel on which MCC device 700 should communicate. The master device determines the channel selection based on a variety of factors, including allocation of existing bandwidth, distribution of devices, and the needs of MCC device 700. Once channel selection logic 710 receives the channel selection information, operation continues with block 1608.

In block 1608, channel selection logic 710 configures MCC device 700 to communicate on the chosen channel. In one embodiment, this includes setting up communications protocols to the extent necessary to provide data communications versus the set-up providing the command and control communications, and/or registering the device in the system with other devices or the host.

In block 1610, if the master device is not detected in block 1602, channel selection logic 710 will switch to a default channel on which to communicate for initialization purposes. As discussed above, the default channel may be a channel that is purely a command/control data channel. In another embodiment, the command/control communications may be integrated with the data communications in each channel. The actual configuration of the communication protocol/architecture is implementation specific. Once channel selection logic 710 has switched to a default channel, operation continues with block 1612.

In block 1612, channel selection logic 710 detects information about the devices communicating on the channel, which includes the number of devices on the channel on which it is communicating and the type of devices they are. This detection may be through the use of a broadcast message sent to all the other devices to request that they identify themselves, or channel selection logic 710 may query a device on the system that already has the information. Once channel selection logic 710 gathers the information, operation continues with block 1614.

In block 1614, channel selection logic 710 will determine if the maximum device limit for the particular channel on which it is communicating has been reached. In one embodiment, the maximum device limit is predetermined based on the implemented communication protocol use for the channel. For example, if USB is the communication protocol used in the channel, and each device includes a function accessible through a hub as described in the current system, a total of 7 devices may be implemented on the channel as configured in the current invention as each function has to be accessed through a hub. In another embodiment, the maximum device limit may be determined by the type of devices that already exist on the channel, the device type of MCC device 700, and the available bandwidth of the communication channel on which all these devices are communicating. Thus, fewer bandwidth intensive devices would be allowed on the same channel to provide the most efficient use of bandwidth. If the maximum device limit has been reached for a particular channel, operation continues with block 1616. Otherwise, operation continues with block 1608.

In block 1616, channel selection logic 710 determines if all channels in the system have been checked in order to find an “available” channel. In one embodiment, if all available channels have been monitored, and no channel is suitable, channel selection logic 710 may select the last channel on which it communicated as the selected channel. In another embodiment, channel selection logic 710 will randomly select a channel on which to communicate. And in yet another embodiment, channel selection logic 710 will pick the channel that has the fewest devices or the least amount of bandwidth load on it. Once an appropriate channel has been chosen, operation will continue with block 1608, where channel selection logic 710 will configure MCC device 700 for communication on this channel. If there are channels that have not been checked, operation will continue with block 618.

In block 1618, channel selection logic 710 switches to a new channel in order to determine if that is an available channel. Operation then continues with block 1612.

Although specific devices are shown for the purposes of description, it will be appreciated that the present invention may be employed with any type of electronic device, including, without limitation, consumer electronics, computer or audio systems, and any type of additional components.

1. A method of determining a communications channel comprising the steps of: (a) detecting whether a host is in a system; (b) if a host is detected, querying the host for a channel on which to communicate and switching a channel selection logic based on a result from the query; and (c) if a host is not detected, determining a channel on which to communicate based on the number of devices on each channel.
